(19) United States
(12) Patent Application Publication
(10) Pub. No.: US 2011/0082888 A1
(43) Pub. Date: Apr. 7, 2011

(54) METHOD FOR EARLY CAREER SERVICES FOR COMMUNICATING WITH A WEB BASED DATABASE AND SOCIAL NETWORK

(76) Inventor: OMAR MARTIN, Freeport (BS)

(21) Appl. No.: 12/573,097

(22) Filed: Oct. 3, 2009

(51) Int. Cl. G06F 17/30

(52) U.S. Cl. 707/784; 707/E17.03

(57) ABSTRACT

A method system and computer readable storage medium for providing information to users of an electronic device in a social network environment may include storing maintaining and organizing information pertaining to registered users of an electronic database, receiving an access request from a registered user and generating a user interface to allow access to the database. A computer program product including a computer-usable medium having computer-usable program code that, when executed, causes a machine to perform the various steps and/or functions described herein.

### RESERVATION OF RIGHTS OF COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to a system and method for establishing and maintaining communication between users of a web based database system.

### BACKGROUND OF THE INVENTION

Many high school students and recent graduates that are interested in attending institutions of higher learning do not fully investigate the programs and degrees offered from one institution to another. It is common for a perspective student to apply to a college based upon geography or reputation without ever engaging a professional to determine what programs the school offers and whether those programs fit the career path the student envisions for themselves. As such, many students who enter college change majors or withdraw prior to completing their first year.

Those students who do attempt to research a particular school are often forced to call or email a school admission office with a question and then wait for a response. However, school admission offices are notoriously busy places and many students quickly learn that their emails and/or phone messages are never returned. As such, perspective students often turn to informal sources such as social networking sites in an attempt to get information. However, the content provided by these sites often does not originate from the actual school and may be inaccurate or misleading.

Several patents have been granted for social networking sites which allow users to connect on line with, others. Several well known patents include; Sudai, et al. U.S. Pat. No. 5,950,200; Abrams U.S. Pat. No. 7,069,308; Zuckerberg at al. U.S. Publication No. 2008/0040474 and Collins U.S. Pat. No. 5,963,951, however, none of these sites satisfies the needs outlined above.

Accordingly, it would be beneficial to provide a means by which prospective students could engage in early career services online in order to receive insight about various career vocations, colleges, universities and institutions prior to, or shortly after, graduating from high school.

### SUMMARY OF THE INVENTION

The embodiments disclosed within this specification relate to communication of information over the internet. One embodiment can include a method for providing information to users of an electronic device in a social network environment that includes storing maintaining and organizing information pertaining to registered users of an electronic database. Another embodiment can include receiving an access request from a registered user and generating a user interface to allow access to the database.

Yet another embodiment of the present invention can include a computer readable storage medium having computer-usable program code that, when executed, causes a machine to perform the various steps and/or functions described herein.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a block diagram of a system for establishing and maintaining communication between users of a web based database in accordance with one embodiment of the present invention.

FIG. 2 is a block diagram of a database in accordance with one embodiment.

FIG. 3 is an exemplary display screen in accordance with one embodiment.

FIG. 4 is an exemplary display screen in accordance with another embodiment.

FIG. 5 is an exemplary display screen in accordance with another embodiment.

FIG. 6 is a flow chart illustrating a method for establishing and maintaining communication between users of a web based database in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

A method and system is provided for allowing direct communication between potential students, educators, institutions of higher learning, career professionals, as well as career agents. This communication is performed online within the context of a social networking environment in which registered users are granted access to a database containing information submitted by other users. Upon accessing this database, registered users can retrieve specific information about colleges, universities and other institutions offering vocational training. As such, students can greatly benefit from conversing directly with representatives of these institutions during a crucial time period in which they are deciding future plans. Additionally, schools themselves can greatly benefit from communicating with perspective students from across the globe. As such, schools can utilize the features of the presently claimed invention to augment recruitment and communicate in an informal manner that is commonly utilized by college aged students.

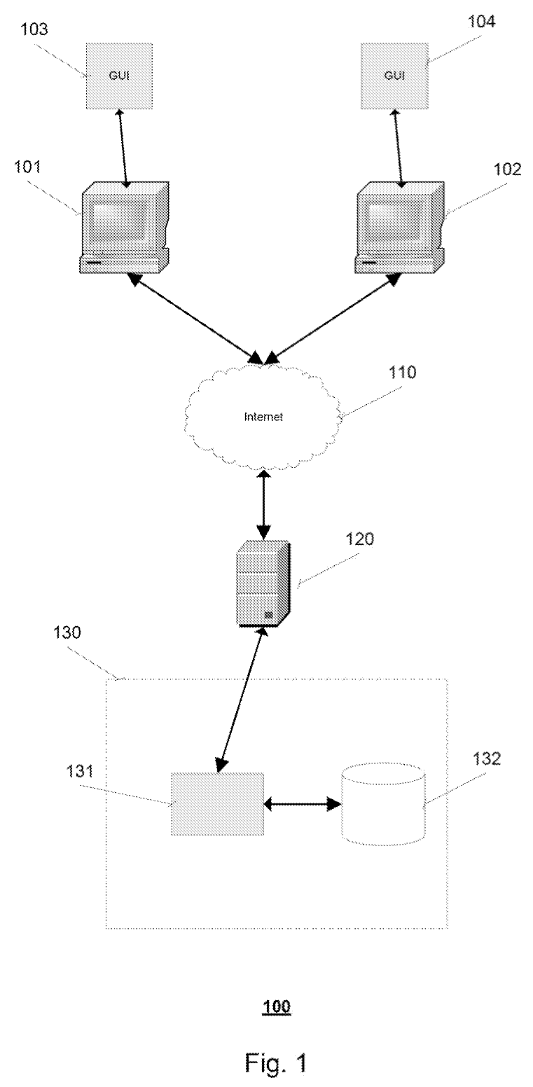

FIG. 1 illustrates a general architecture of a system that operates in accordance with one embodiment of the present invention. As shown in FIG. 1, the system 100 includes a plurality of interface devices 101 and 102 connected to a database system 130 via an interface gatekeeper 120 and the internet 110. The user interfaces 101 and 102 may be any mechanism by which an external individual, computer or device can obtain and provide data, respectively to or from the database system 130 of the present invention. The interface devices 101 and 102 may be configured to display a graphic user interface (GUI) 103 and 104, respectively that includes information such as a website or e-mail message. The interface gatekeeper 120 may be a server or other such device for determining user access to the database system 130. The database system 130 includes an application server 131 and a database 132. The application server 131 is a server or other such device responsible for generating content as well as exchanging information with the interface devices 101 & 102 and the database 132.

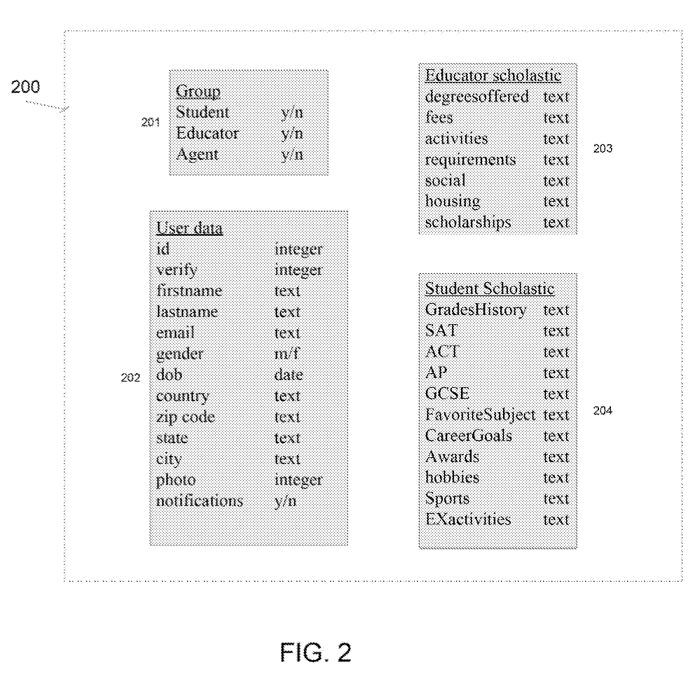

FIG. 2 illustrates a block diagram of data 200 that may be stored within database 132. According to this non-limiting embodiment, registered users of the database system 130 may be subdivided into groups 201 based upon predetermined criteria. For example, registered users may be placed into groups and classified as Students, Educators, career professionals, or Agents. In one embodiment, a student may include soon-to-be high school graduates, recent graduates or other individuals interested in receiving information about various career training opportunities. Educators may include individuals associated with institutions of higher learning. These institutions can be community colleges, vocational schools, universities or virtually any institution that provides career training. Finally, Agents may include individuals or groups who provide assistance to students in choosing educators that specialize in a desired career path. Additional information that can be stored includes, for example: User data 202, Educator scholastic 203, and/or Student scholastic 204.

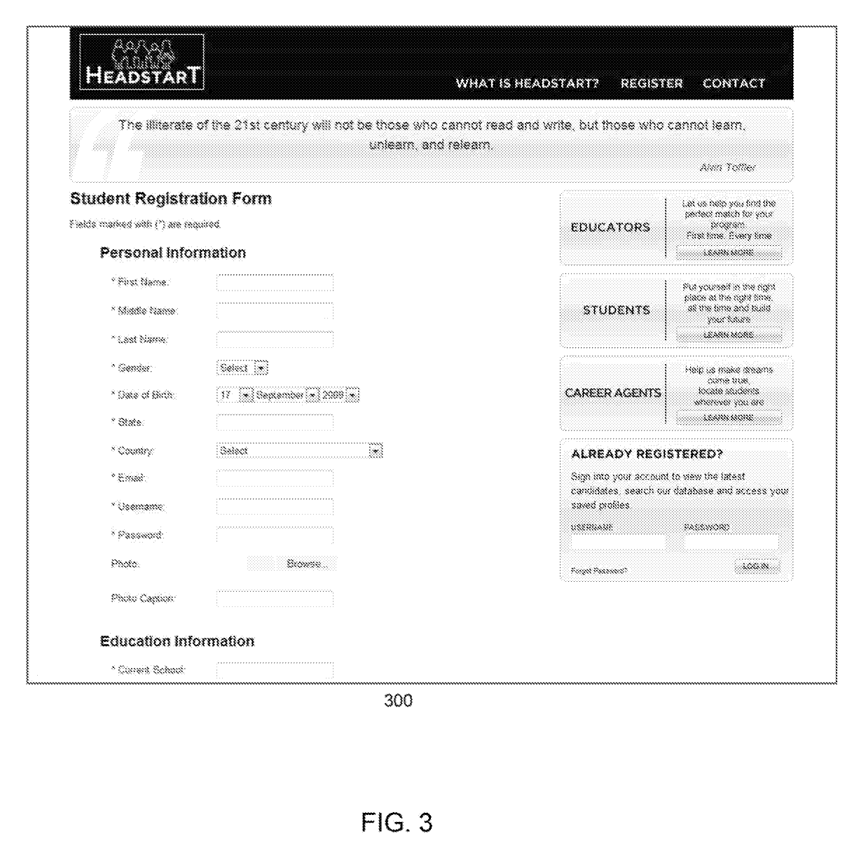

FIG. 3 illustrates an exemplary presentation screen generated by the application server 111 to be displayed as a GUI 103 or 104 of an interface device 101 or 102. In this example, a student registration screen 300 is generated in response to a registration request from a student. This registration screen 300 may request a student to provide information including but is not limited to: photos, name, date of birth, gender, grades history, location, SAT scores, ACT scores, AP scores, GCSEs, Favorite Subjects, Preferred Careers aspirations, Award, Hobbies, References, Extracurricular Activities, username and password.

Upon receipt of this information, the interface gatekeeper 120 determines eligibility of the student based on predetermined criteria. As used herein, predetermined criteria may include, but is not limited to: the location of the student, completeness of the application, verifiable facts, grades, activities, hobbies, intended career path or system resources. If approved, the student is classified as a registered user and his/her registration information is entered into the database 132 where it is available to be viewed by other registered users.

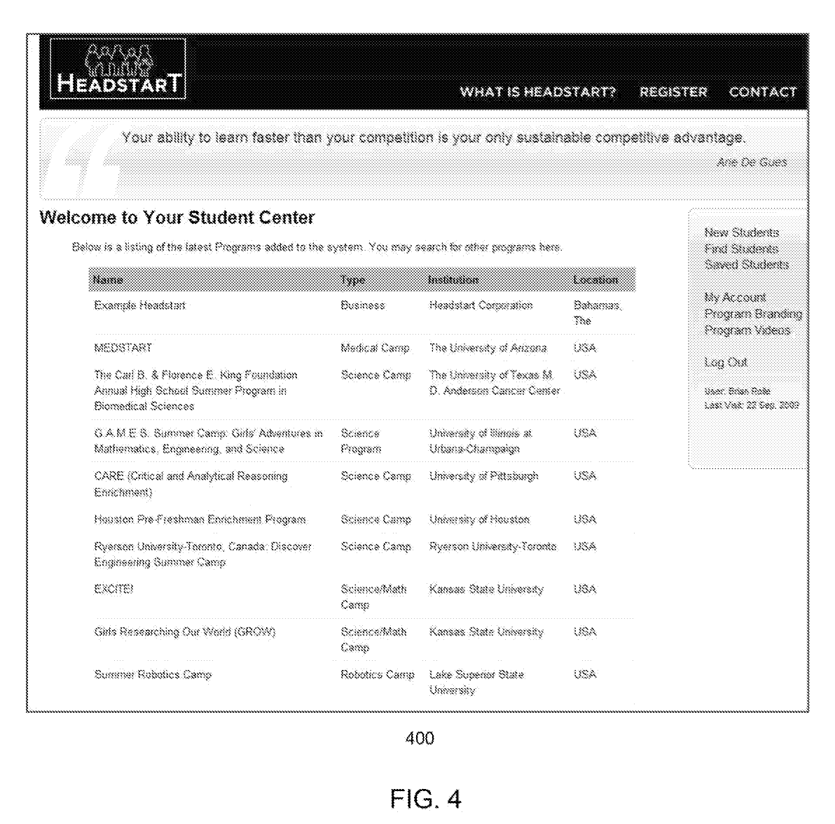

As illustrated by FIG. 4, once a user is registered with the database system 130, that user may access the database 132 via the various options provided by the application server 131. In this non-limiting example, the student can access presentation screen 400 which allows the student to view the latest programs registered into the system by educators, colleges universities or institutions. The student can click on a listed program to view its profile and even save it to their personal profile. Additionally, the student can request additional information directly from any educator registered within the system. Other options that may be available include: New Programs: Students are allowed to view the latest programs from wherever they are in the system. Find Programs: Students can find programs by sorting different parameters such as program name, type, institution, city, state, country, entry fee, # of entry spaces, duration, dates, deadline, and career choice. Saved Program: Students can view all programs they have saved to their profile. My inbox: Students can enter their inbox, send, receive and delete emails from students in the system, enter students in their address book, and create folders. They can also receive emails from registered educators, colleges and institutions and return emails to them. Career Explorer: Students can explore information on various careers. Information such as career overviews, salary guides, notable figures, and scholarship information. Career Portal: Students can enter various chat rooms. Each room is dedicated to a specific career. They can view videos specific to that career from educators and professionals. They chat using their profile photo which is cartoonized. My Account: Student s can view their profile information upon registration and change it if they wish to. My Videos: Students can upload profile videos for colleges, universities, educators to view answering questions regarding their career aspiration and achievements. Refer a Friend: Students can send emails to up to five (5) other students inviting them to use the system. My Yearbook: Students can create their own yearbook, uploading videos & photos of students and teachers. Students registered in the system are automatically updated in their yearbook. They can choose who is the most popular, most smart, etc. Although the above described embodiment outlines options for students, the invention is not limited to any particular class or group. For example other embodiments include groups such as career agents or parents. To this end, the above list is intended to be illustrative and not limiting.

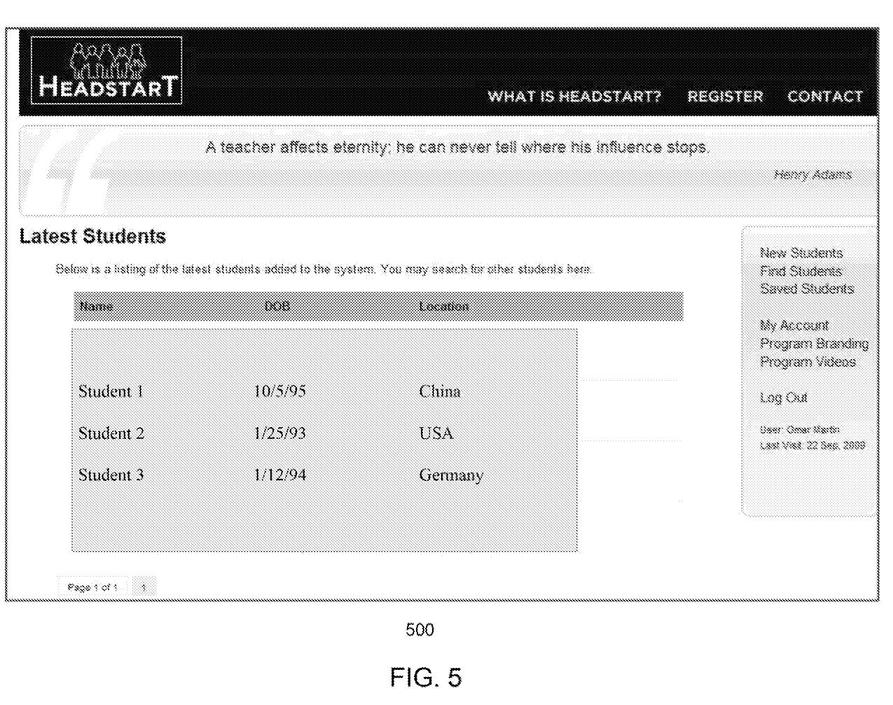

As FIG. 5 illustrates, registered users are not limited to students or agents. In this example, educators registered to use the database system 130 may access the database 132 via the various options provided by the application server 131. In this example, the educator can access presentation screen 500 which allows the educator to view new students who have registered into the system. Educators can click on the students name and view their profile, they can chose to save the student to their profile, request information, email the student or return to the previous page. Other options that may be available include: New Student: Educators are allowed to view the latest students from wherever they are in the system. Find Students: Educators can find students by sorting different parameters such as student name, city, state, country, age, gender, grade, Sat score, career choice, and favorite subject. Saved Students: Educators can view all students they have saved to their profile. My inbox: Educators can enter their inbox, send, receive and delete emails from students in the system, enter students in their address book, and create folders. Career Explorer: Educators can explore information on various careers. Information such as career overviews, salary guides, notable figures, and scholarship information. Career Portal: Educators can enter various chat rooms. Each room is dedicated to a specific career. They can upload and view videos specific to that career. My Account: Educators can view their profile information put in upon registration and change it if they wish to Program Branding: Educators can upload logos for a specific program. Program Videos: Educators can upload videos regarding their programs. The above list is intended to be illustrative and not limiting.

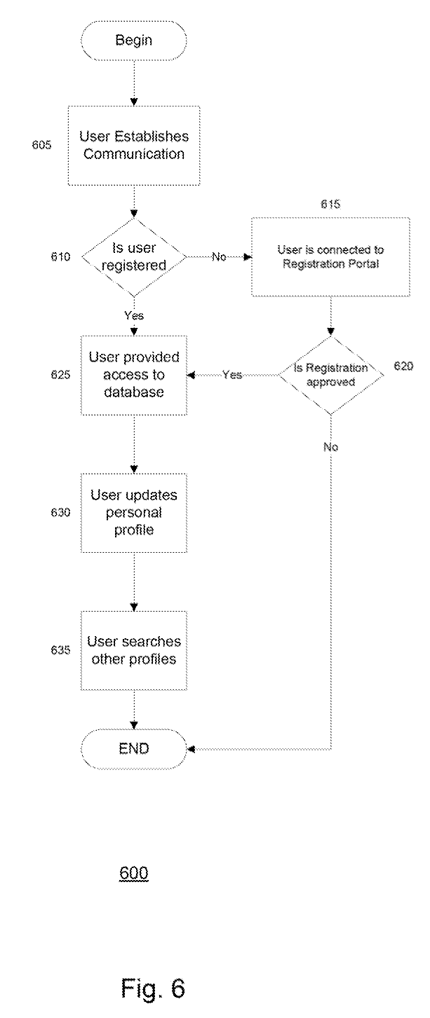

FIG. 6 illustrates a flow diagram 600 of a method for establishing and maintaining communication between users of a web based database in accordance with one embodiment of the present invention. Aspects are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Accordingly, at step 605 a user establishes communication with the interface gatekeeper via the internet.

In step 610 the system prompts the user to identify themselves as a registered user by entering their assigned username and password. If the information submitted is correct, the registered user is provided access to the database in step 625. If the user does not have a username or password they are directed to the registration portal of step 615.

In step 615, the system generates a registration form for the user to complete.

In step 620, the information provided by the user is reviewed and if approved, the user is issued a username and password and provided access to the database in step 625. If the user is not approved, they are notified why and are not given access to the database.

In step 630, the registered user is prompted to update their profile with any new information they wish to make public.

In step 635, the registered user utilizes the features of the application server to search the database and contact other registered users.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing information to users of an electronic device in a social network environment, said method including:
maintaining, via a processor, a database of registered users;
organizing registered users into one of at least three groups based upon a predetermined criteria;
storing, via a memory, information pertaining to each registered user, said information including public information that is accessible by other registered users and private information that is not accessible by other registered users;
receiving a request for access to the database; and
generating a user interface to allow registered users to access the database.

2. The method of claim 1, further comprising:
determining if the request for access originated from a registered user; and
issuing one of an acceptance notice or a rejection notice, wherein the acceptance notice is issued to a registered user and the rejection notice is issued to a non-registered user.

3. The method of claim 1, wherein the user interface allows registered users from one of the at least three groups to view public information pertaining to registered users from the same or another of the at least three groups

4. The method of claim 3, wherein the user interface includes options unique to each of the at least three groups.

5. The method of claim 1, wherein members of a first group include registered users desiring to receive a service, members of a second group include registered users desiring to provide a service, and members of a third group include registered users desiring to encourage non registered users to join one of the first or second groups.

6. The method of claim 5, wherein members of the first group include students, members of the second group include educators, and members of the third group include career agents.

7. A computer readable storage medium encoded with instructions, which when executed by a processor, causes the processor to perform a method for providing information to registered users of an electronic device in a social network environment, said method including:
maintaining a database of registered users;
organizing registered users into one of at least three groups based upon predetermined criteria;
storing, via a memory, information pertaining to each registered user, said information including public information that is accessible by other registered users and private information that is not accessible by other registered users;
receiving a request for access to the database; and
generating a user interface to allow registered users to access the database.

8. The computer readable storage medium of claim 7, further comprising:
determining if the request for access originated from a registered user; and
issuing one of an acceptance notice or a rejection notice, wherein the acceptance notice is issued to a registered user and the rejection notice is issued to a non-registered user.

9. The computer readable storage medium of claim 7, wherein the user interface allows registered users from one of the at least three groups to view public information pertaining to registered users from the same or another of the at least three groups

10. The computer readable storage medium of claim 9, wherein the user interface includes options unique to each of the at least three groups.

11. The computer readable storage medium of claim 7, wherein members of a first group include registered users desiring to receive a service, members of a second group include registered users desiring to provide a service, and members of a third group include registered users desiring to encourage non registered users to join one of the first or second groups.

12. The computer readable storage medium of claim 11, wherein members of the first group include students, members of the second group include educators, and members of the third group include career agents.

13. A system for implementing a method for providing information to registered users of an electronic device in a social network environment, said method including:
means for maintaining a database of registered users;
means for organizing registered users into one of at least three groups based upon predetermined criteria;
means for storing information pertaining to each registered user, said information including public information that is accessible by other registered users and private information that is not accessible by other registered users;
means for receiving a request for access to the database; and
means for generating a user interface to allow registered users to access the database.
